(19) United States
(12) Patent Application Publication
(10) Pub. No.: US 2008/0180665 A1
(43) Pub. Date: Jul. 31, 2008

(54) Measuring color spectra using color filter arrays

(76) Inventors: David J. Redman, Boise, ID (US); Steve A. Jacob, Boise, ID (US); Randall G. Guay, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/701,087

(22) Filed: Jan. 31, 2007

(51) Int. Cl. G01J 3/28

(52) U.S. Cl. 356/326

(57) ABSTRACT

Embodiments including color filter arrays are disclosed.

### INTRODUCTION

Color measurement instruments can be broadly classified as calorimeters, abridged spectrometers, and spectrometers. Devices that measure reflected light are called photometers, e.g., spectrophotometer, whereas devices that measure emitted light are called radiometers, e.g., spectroradiometer. Some color measuring devices can measure both reflective and emissive objects. In general, spectrometers are more color accurate than abridged spectrometers which are in turn more color accurate than calorimeters. This is often due to a decreasing number of color channels as devices proceed from full spectrometers to colorimeters.

The number of color channels can be associated with sampling theory. The more color channels, the finer the sampling of a light spectrum associated with a particular color. Colorimeters may have 3-4 color channels, abridged spectrometers may have 5-16 channels whereas spectrometers may have 17 or more channels. The number of channels associated with a particular classification of instrument is somewhat flexible, particularly between abridged and full spectrometers.

Typically, the signal associated with a color channel arises from the collection of light energy from a range of continuous wavelengths. For example, the light energy passing through a color filter that transmits wavelengths from a range such as 380-500 nm onto an electronic sensor that generates a signal, can be called the ‘Blue’ channel signal. To create a color channel, light has to be separated into multiple ranges of wavelengths.

Most instruments are based on a small set of light-separation technologies. These technologies include: (1) diffraction gratings; (2) interference filters; (3) color filter arrays; and (4) Light Emitting Diode (LED) based designs.

Technologies 1-3 separate light into ranges of wavelengths which then falls on multiple sensors to generate a simultaneous set of signals. LED-based designs use a monochromatic sensor and a series of different colored LED's which are turned on one-at-a-time to generate a sequence of signals. Color filter arrays (CFA's) have used 3-4 color channels which are found in calorimeters.

Illumination sources are an important component of color measuring instruments. Higher-cost instruments often use annular tungsten-halogen tubes to generate a light source that is relatively well-behaved, that is, they are spectrally smooth across the desired measurement wavelength range, e.g., 380-730 nm.

Lower-cost instruments often use LED's. LED's by their very nature are not spectrally smooth, i.e., they have ‘spikey’ spectra, and they emit light in very narrow wavelength ranges. Even so-called ‘white light’ LED's are not well-behaved and usually do not span the desired illumination wavelength range, e.g., 380-730 nm.

### BRIEF DESCRIPTION OF THE DRAWINGS

FIG. 1 illustrates an example printing device suitable to implement embodiments of the present disclosure.

FIG. 2 illustrates a representation of a three color filter array.

FIG. 3 illustrates a representation of a color filter array having a number filters formed with materials having different color characteristics according to an embodiment of the present disclosure.

FIGS. 4A-4C illustrate representations of sensing circuits having a number of color filter configurations, including combining at least two materials having different color characteristics, according to embodiments of the present disclosure.

FIG. 5 illustrates a representation of a set of example light transmission curves for an eight color filter array.

FIG. 6 illustrates a representation of light sources emitting light with differing intensities across a visible color spectrum according to an embodiment of the present disclosure.

FIG. 7 illustrates a configuration for directing incident light and receiving reflected light according to an embodiment of the present disclosure.

FIG. 8 illustrates another configuration for directing incident light and receiving reflected light according to an embodiment of the present disclosure.

FIG. 9 is a block diagram illustrating a method of measuring color according to an embodiment of the present disclosure.

### DETAILED DESCRIPTION

Embodiments of the present disclosure include systems, devices, and methods for providing an abridged spectrophotometers and/or spectroradiometers. For example, in some embodiments through use of a larger number of color channels, e.g., greater than about 6 or 8, it is possible to reconstruct or estimate the original spectral content of a measured color for reflective objects. The present disclosure includes embodiments that describe the use of CFA's with 5 or more color channels to create such devices.

The present disclosure also includes a number of embodiments that use multiple illumination sources to solve various color measurement problems. In such embodiments, the arrangement of light sources and/or lightpipes can be adjusted to compensate for paper positional errors or characteristics (e.g., cockle) and, in some embodiments, the lightpipe can be used to direct light and/or adjust the shape and the uniformity of the light striking the object.

The visible spectrum can be defined as light with wavelengths approximately between 400-700 nm. For example, the wavelength range of 380-730 nm can be considered the visible spectrum for many applications, which constitutes a range of 350 nm (i.e., 730 nm minus 380 nm).

Some color capture devices that have been proposed, such as some digital cameras, use 3 filters to separate the incoming visible light into 3 channels of color information. Most digital cameras that use on-chip Color Filter Arrays (CFA) have RGB (red, green, and blue) transmissive color filters, while some use CMY filters (cyan, magenta, and yellow). Such filters have transmission curves which are relatively broadband having widths of about 150 nm or so (e.g., usually a little larger than 350/3≈117).

When using these filters, a portion of the spectrum passes through each filter onto a number of sensors which create signals proportional to the total light energy passing through each filter. For example, if a blue (B) filter allows light from 380-560 nm to be transmitted to the sensor beyond the filter, the total light energy transmitted through the filter is integrated by the sensor to produce a single B signal or value. The same is true for the R and G filters. Consequently, the spectrum of any impinging color produces 3 channels of color information, 3 signals associated with the R, G, and B filters.

Unfortunately, in such systems, it is possible for two colors with different spectra to produce the same RGB values. This phenomenon is often referred to as instrument metamerism (e.g., multiple colors producing the same instrument reading).

This is possible for the B channel, for example, since the light spectra in the 380-560 nm range may be different on a wavelength-by-wavelength basis, but may integrate across the B wavelength range to generate the same B value at the sensor. For instance, color #1 might have more light energy at 423 nm while color #2 might have more energy at 516 nm.

However, if the total light energy transmitted through the B filter to the B sensor is the same, the B values will be the same and, hence, indistinguishable from the standpoint of the B signal. If this is true for the R and G signal, as well, then RGB₁=RGB₂. Consequently, color #1 and color #2 can be indistinguishable to the instrument even though the two colors may appear very different to the human observer.

One way to reduce instrument metamerism and/or improve color accuracy in general is to use more than 3 channels of color information. In general, more color channels can result in higher color accuracy

Highly accurate instruments might be obtained using 35 or even 70 channels whereas less accurate instruments might be obtained using 6-16. However, the law of diminishing returns is generally at work in such implementations. That is, 70 channels may not be twice as accurate as 35 channels.

For general purpose color measurement work, 6-12 channels can be used to produce acceptable color accuracy. Such additional channels of color information can be created with additional filters (e.g., 8 color channels can be accomplished by utilizing 8 color filters).

There are several methods of creating additional filters. For example, with on-chip CFA's, existing RGBCMY filters may be combined in several ways. These may include, but are not limited to, different manufacturing procedures, such as, for example, stacking 2 or more filter materials, mixing 2 or more filter materials, varying the thicknesses, and/or varying the concentration of the colorant or material, among other manners of creating filters with different color characteristics.

Labor and material costs can be reduced by combining materials with different color transmittance characteristics. For example, as described below, combining a material used in a filter having a blue (B) transmittance intensity peak with a material used in a filter having a magenta (M) transmittance intensity peak can result in a color filter having a different transmittance than either a B or M color filter.

As such, a combined B-M color filter, for example, can be used in addition to, or instead of, another color filter to contribute to forming a color filter array (CFA). A C-M filter might be combined by mixing C and M colorants together before on-chip deposition or by stacking C and M filters on top of each other, one after the other.

Accordingly, among various embodiments of the present disclosure, a color measuring device can detect a color spectrum of an object using a number of color filters, where a number of materials each having a different color spectral characteristic are used to form an array of color filters transiting at least five portions of the color spectrum. The color measuring device can utilize at least one color filter that is a combination of at least two of the number of materials having a different color spectral characteristic.

The color filters can be associated with circuitry for sensing an intensity of a portion of the color spectrum transiting each associated color filter. System and/or color measuring device embodiments can interpret the intensities of the sensed portions of the color spectrum as measurements thereof by using a processing circuit.

In some embodiments, transiting at least five portions of the color spectrum can be performed by using each of at least five color filters to provide a fraction of the spectrum of light, within one of the portions of the color spectrum, to the circuitry for sensing the intensity thereof. In various embodiments, selecting particular color filters can be performed based upon a shape of a color spectrum fraction transiting each color filter to be used in the array such that the portions are spaced across a range that substantially covers a visible color spectrum. The spacing may be in substantially regular interval across the range or in irregular intervals across the range. In some instances the use of substantially regular spacing may be beneficial in providing better overlap between filters and/or coverage of the range, among other benefits.

Characteristics regarding the shape of the color spectrum transiting each color filter that can affect consideration of a particular filter for an array can include height, width, area under the curve above a particular transmittance wavelength range, and/or location of the particular transited spectrum within the visible color spectrum, among other factors. Determination of a particular combination of color filters that can be used in a CFA can be based upon simulations, modeling, and/or experimentation, among other considerations. In some embodiments, selecting color filters can be performed such that the peaks of the at least five portions of the color spectrum are spaced at intervals across a visible color spectrum.

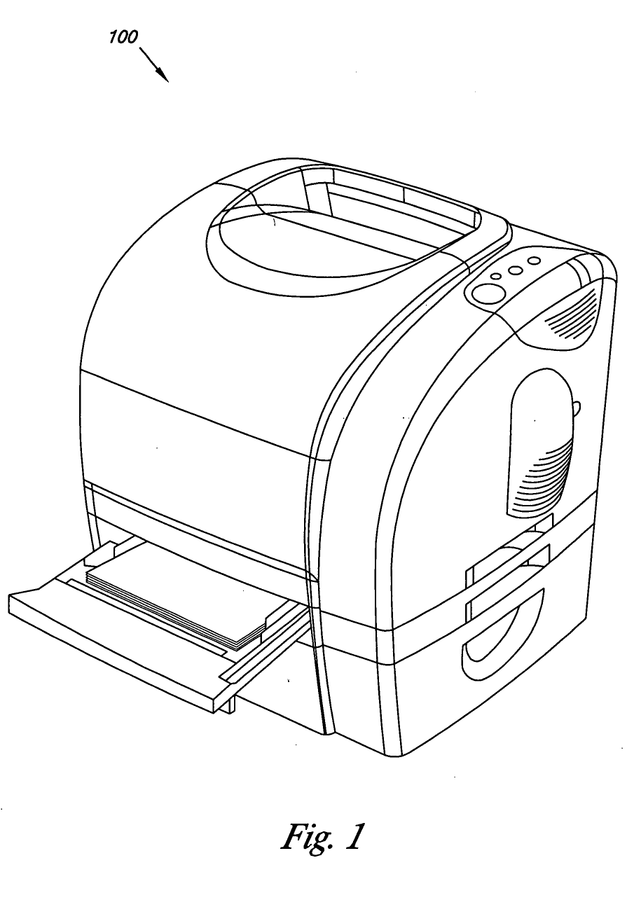

FIG. 1 illustrates an example printing device suitable to implement embodiments of the present disclosure. The printing device 100 of FIG. 1 can include a color imaging functionality that measures color intensities in an image to be reproduced. Color imaging devices, as exemplified by the printing device 100, can use a color measuring component that implements CFA sensors as described below.

In some embodiments, the color intensity values measured by the CFA sensors can be stored for image reproduction at a time determined by a user. By way of example and not by way of limitation, color imaging devices that can utilize embodiments of color measuring components of the present disclosure can include various embodiments of printers (e.g., inkjet, laser, etc.), scanners, facsimile (fax) machines, and digital cameras, among others.

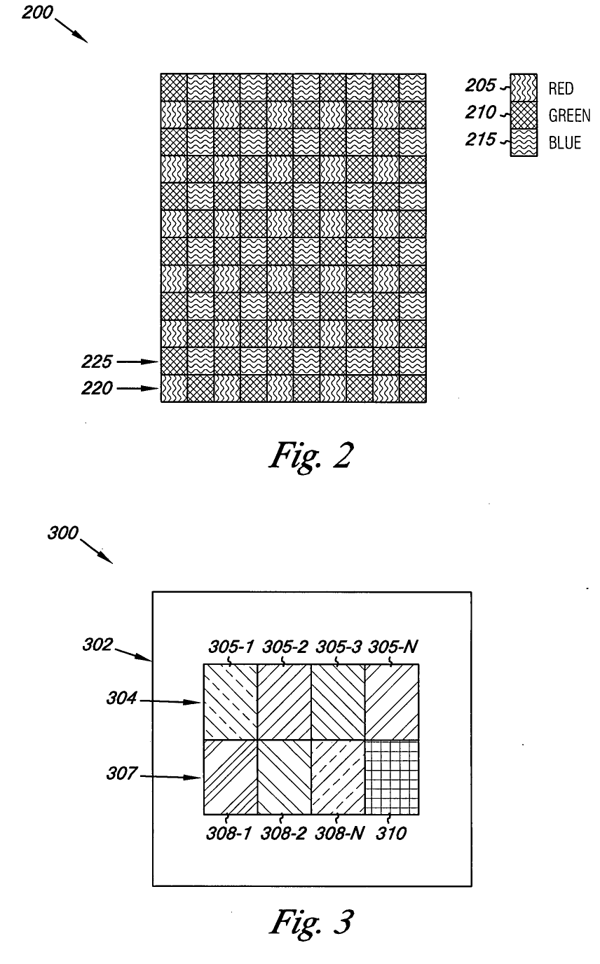

FIG. 2 illustrates a representation of a three color filter array. The color filter array 200 shown in FIG. 2 is a schematic representation of color filter arrangements using three materials each having a different color spectral characteristic that are used to form an array of color filters (e.g., which are used in digital camera sensors).

The color filter array 200 shown in FIG. 2 can represent various types of three color filter arrays. As such, the filter colors shown, the placement of the filter colors in the array, and the proportion of one color filter to another color filter are illustrated by way of example and not by way of limitation.

As described throughout the present disclosure, a color filter can be labeled with a particular color (e.g., a red filter) and/or a material can be labeled as contributing to a particular color (e.g., a green color). It is to be understood that the color filter and/or material is labeled as such as an abbreviated form of stating that the color filter and/or material can allow transit of light having a peak wavelength intensity in a portion of the color spectrum identified with the particular color label being used. For example, referring to a particular color filter as a Blue (B) filter is intended to describe a filter that transits a peak wavelength intensity in a portion of the color spectrum classifiable as blue, which can include a range of wavelengths.

The embodiment of the three color filter array 200 illustrated in FIG. 2 includes Red (R) filters 205, Green (G) filters 210, and Blue (B) filters 215, as shown in the legend of FIG. 2. For purposes of illustration and not limitation, the three color filter array 200 has twelve (12) rows of color filters and ten (10) columns of color filters, thereby yielding a total of 120 color filters.

The pattern discussed with respect to FIG. 2 is provided as one example, the present disclosure can be utilized with various other types of patterns, and as such, the discussion of FIG. 2 should be viewed as illustrative rather than limiting. The bottom row 220 of color filters is shown as starting on the left with an R color filter followed in the next space in row 220 of the array 200 by a G color filter. The remaining spaces in row 220 of the array 200 are occupied by a similarly alternating series of R and G color filters. Hence, row 220 of the array 200 is shown as having five (5) individual R color filters and five (5) individual G color filters.

The second row 225 up from the bottom of the three color filter array 200 illustrated in FIG. 2 is shown as starting on the left with a G color filter followed in the next space in row 225 of the array 200 by a B color filter. The remaining spaces in row 225 of the array 200 are occupied by a similarly alternating series of G and B color filters. Hence, row 225 of the array 200 is shown as having five (5) individual G color filters and five (5) individual B color filters.

In the embodiment of the RGB color filter array 200 illustrated in FIG. 2, the arrangement of color filters in the bottom pair of rows (i.e., rows 220 and 225) is shown to repeat itself in the next five (5) pairs of rows of color filters progressing upward from the bottom pair. Hence, the total of 120 color filters shown in the RGB color filter array 200 illustrated in FIG. 2 includes thirty (30) R color filters, sixty (60) G color filters, and thirty (30) B color filters.

Portions of a color spectrum of light transited to sensors by three colors of filters can be limited to three peak wavelength intensities interpretable as measurements thereof. Reproduction of a captured image (e.g., by a printer or a digital camera) of an object using measurements of the three peak wavelengths can result in an image having a mixture of colors that appears to differ from that of the original object.

In some embodiments of CFAs that use a limited number of materials each having a different color spectral characteristic to form an array of color filters, adjustments in the proportion of numbers of each color filter to the other color filters can be made in an attempt to enhance the appearance of resulting image reproductions. For example, the RGB filter array 200 illustrated in FIG. 2 is shown to have twice as many G color filters (60) as R color filters (30) and, similarly, twice as many G color filters (60) as B color filters (30).

Because sensitivity of human color perception in the middle portion of the color spectrum (e.g., where the color green is located) differs from that of the sensitivity toward both ends of the color spectrum (e.g., where the colors red and blue are separately located) using more G color filters in a RGB color filter array can be done in an attempt to compensate for the differing sensitivities. For example, as shown in the RGB color filter array 200 of FIG. 2, using twice as many G color filters as each of the number of R color filters and B color filters in association with a sensor for the intensity of light transited by each color filter can result in a cumulative signal measurement for the green color of an object that is twice what it otherwise would be. The relative number of filters can also be adjusted to meet other goals besides matching human color perception, in some embodiments.

Such adjustments of color measurements can be used in an attempt to compensate for measurement of peak intensities in a limited number of portions of the visible color spectrum. However, when color intensities are measured using more color filters that can provide a peak intensity of light within more portions of the color spectrum, in order to allow the circuitry for sensing the intensities to provide more measurements within a range of the color spectrum, the accuracy of the measured colors can be improved and/or the reproduction of colors in an image can be enhanced thereby, for example. Additionally, selecting color filters such that the peaks of the portions of the color spectrum are spaced at intervals across a visible color spectrum can contribute to enhancement of the image reproduction.

FIG. 3 illustrates a representation of a color filter array having a number of filters formed with materials having different color characteristics according to an embodiment of the present disclosure. FIG. 3 illustrates a representation of an embodiment of a CFA 300 that includes an arrangement of eight (8) different color filters each having a different color spectrum transiting characteristic that are used to form an array of color filters.

The CFA 300 shown in FIG. 3 can represent various types of CFAs. As such, the number of filter colors shown, the placement of the filter colors in the array, and the proportion of one color filter to another color filter are illustrated by way of example and not by way of limitation. For example, the CFA 300 has two (2) rows of color filters and four (4) columns of color filters, thereby yielding a total of eight (8) color filters. However, CFAs of the present disclosure can include five or more color filters positioned in any configuration in front of 1 or more sensors for detecting a color spectrum of an object.

Embodiments of the present disclosure include a number of materials each having a different color spectral characteristic that, for example, can be used to form an array of color filters transiting at least five portions of the color spectrum. For example, five materials each having a different color spectral characteristic can be used to form five different color filters that transit portions of a color spectrum having five different peak intensities.

In some embodiments of the present disclosure, a fifth given color filter can be formed using a combination of two or more materials that includes a combination of materials. Moreover, in various embodiments, one or more of the color filters that can be used in an array of color filters transiting at least five portions of the color spectrum can be formed using a combination of at least two materials each having a different color spectral characteristic. For example, Cyan (C) and Magenta (M) filters may be combined in various ways to produce a color filter that is unique from either C or M.

In the embodiment of the CFA 300 shown in FIG. 3, the array of color filters can be positioned in association with circuitry 302 for sensing an intensity of a portion of the color spectrum transiting each associated color filter. Some embodiments of CFA 300, by way of example and not by way of limitation, can include a first row 304 that includes a number of color filters 305-1, 305-2, 305-3, . . . 305-N that can use a number of materials each having a different color spectral characteristic to form different color filters that transit portions of a color spectrum having different peak intensities.

The embodiment of the CFA 300 can include a second row 307 that includes a number of color filters 308-1, 308-2, . . . 308-N that, in some embodiments, can use a number of materials each having a different color spectral characteristic to form different color filters that transit portions of a color spectrum having different peak intensities. In some embodiments, each of the examples of color filters (i.e., 305-1, 305-2, 305-3, . . . 305-N) in the first row 304 can use materials having a color spectral characteristic that is different from the color spectral characteristics of each of the example color filters (308-1, 308-2, . . . 308-N) in the second row 307.

As illustrated in the embodiment of CFA 300 shown in FIG. 3, by way of example and not by way of limitation, the second row 307 of the CFA 300 can include a color filter 310 that is a combination of at least two of the number of materials, as described above. The CFA 300 can represent various embodiments of CFAs that can be included in various embodiments of color measuring devices where each of the at least two materials can have a different color spectral characteristic.

Such CFA embodiments can include a number of sensing circuits for sensing light transiting at least one of the filters, where each of the filters is associated with at least one sensing circuit. The CFAs can be further associated with a processing circuit to interpret the color spectral characteristics of the sensed light as at least five color channels, where the number of filters used can enable the color measuring device to measure the color channels as spaced in a color spectrum.

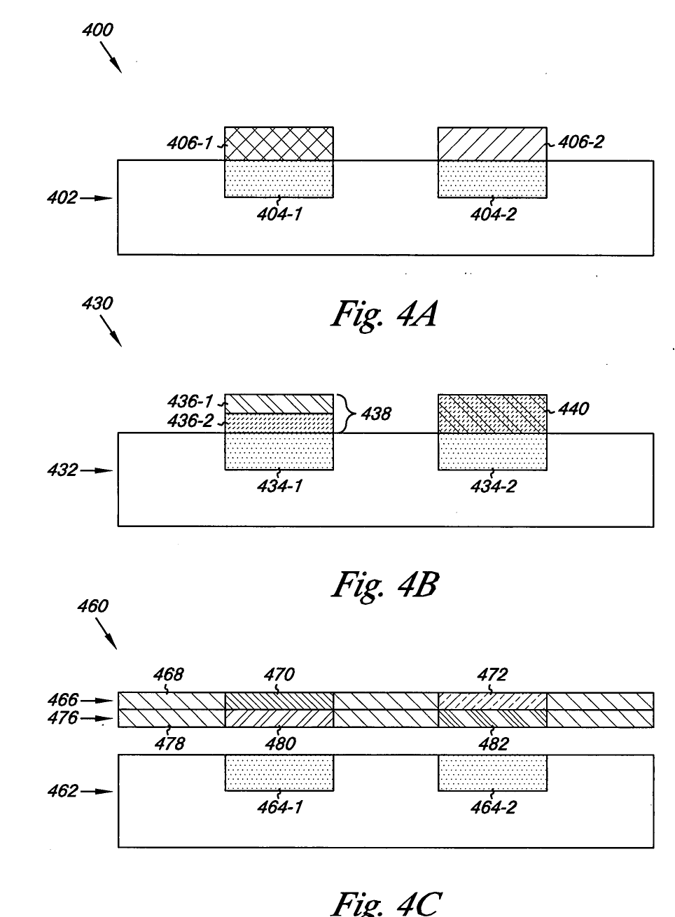

FIGS. 4A-4C illustrate representations of sensing circuits having a number of color filter configurations, including combining at least two materials having different color characteristics, according to embodiments of the present disclosure. FIG. 4A illustrates an embodiment of a CFA 400 that includes a representation of associated circuitry 402 (e.g., a circuit board) that can be connected to a processing circuit. The circuitry 402 of the CFA 400 embodiment can be associated with a number of sensors (e.g., photodiodes) that can enable registering of an intensity of light being sensed.

By way of example and not by way of limitation, each sensor 404-1, 404-2 shown in the embodiment of CFA 400 can be associated with at least one color filter. For example, sensor 404-1 can be positioned under color filter 406-1 and sensor 404-2 can be positioned under color filter 406-2, among other possible configurations.

In the embodiment of CFA 400, color filter 406-1 is shown to be formed using a material with a color spectral characteristic different from that of the material used to form color sensor 406-2, as indicated by the different patterns used to illustrate each color sensor. As previously described in the present disclosure, materials having different color spectral characteristics can allow transit of light in portions of a color spectrum having different peak intensities.

FIG. 4B illustrates an embodiment of a CFA 430 that includes a representation of associated circuitry 432 that can be connected to a processing circuit, as described previously with regard to FIG. 4A. By way of example and not by way of limitation, the circuitry 432 of CFA 430 can be associated with two sensors 434-1, 434-2, as described previously with regard to FIG. 4A. The sensor 434-1 of CFA 430 can have two or more color filters 436-1, 436-2 formed using materials having different color spectral characteristics that are, in some embodiments, associated with the sensor 434-1 by being layered over the sensor 434-1.

Forming layered color filters is an embodiment of combining at least two color filter materials that can allow transit of light in a portion of a color spectrum having a peak intensity different from each of the peak intensities of the individual color filters. For example, the layered color filter 438 of CFA 430 in the embodiment of FIG. 4B can, in some embodiments, allow transit of light in a portion of the color spectrum that can have a peak intensity at a wavelength that is longer than, between, or shorter than the wavelength of the peak intensity transited by color filter 436-1 and the wavelength of the peak intensity transited by color filter 436-2.

The CFA 430 shown in FIG. 4B can, in various embodiments, include a combined color filter 440 that can be formed, for example, by mixing the materials used in the layered color filter 438. Forming color filters by mixing materials is another embodiment of combining at least two color filter materials that can allow transit of light in a portion of a color spectrum having a peak intensity different from each of the peak intensities of the color filters formed from one of the materials.

For example, the layered color filter 440 of CFA 430 in the embodiment of FIG. 4B can, in some embodiments, allow transit of light in a portion of the color spectrum that can have a peak intensity at a wavelength that is longer than, between, or shorter than the wavelength of the peak intensity transited by color filter 436-1 and the wavelength of the peak intensity transited by color filter 436-2. In some embodiments, the peak intensity wavelength transited by the mixed color filter 440 can be different from the peak intensity wavelength transited by the layered color filter 438, which can result from proximal interaction of materials, varying proportions, different manufacturing procedures, or the like, as discussed above, resulting in different color spectral characteristics in the mixed color filter 440.

FIG. 4C illustrates an embodiment of a CFA 460 that includes a representation of associated circuitry 462 that can be connected to a processing circuit, as described previously with regard to FIG. 4A. By way of example and not by way of limitation, the circuitry 462 of CFA 460 can be associated with two sensors 464-1, 464-2, as described previously with regard to FIG. 4A. The CFA 460 can have circuitry 462 and sensors 464-1, 464-2, in some embodiments, at least partially covered by a light-permeable film (e.g., a layer or sheet) upon which a material, or colorant, can be applied to, printed on, embedded in, or formed into, which can have a color spectral characteristic different from that of the light-permeable film

By way of example and not by way of limitation, the embodiment of CFA 460 illustrated in FIG. 4C shows a number of layers of light-permeable film 466, 476 positioned over the representation of the circuitry 462 and the sensors 464-1, 464-2. The number of colorant or filter layers can be 1 or more.

For example, the embodiment of film 466 shows a portion 468 of film without colorant. The embodiment of film 466 shows a first section 470 in which at least one colorant has been printed, for example, and second section 472 in which at least one other colorant, in some embodiments, has been applied (e.g., by layering, printing, or mixing). In some embodiments, as shown in FIG. 4C, the sections of the light-permeable film upon which colorant has been printed, for example, can be separated by portions where a colorant is not layered or printed thereon, or mixed therein.

In the embodiment of CFA 460 illustrated in FIG. 4C, the light-permeable film 466 can be positioned over at least one other light-permeable film 476. As described for film 466, light-permeable film 476 can have a portion 478 of film without colorant. The embodiment of film 476 shows a first section 480 in which at least one colorant has been printed, for example, and second section 482 in which at least one other colorant, in some embodiments, has been layered, for example.

As shown in the embodiment of CFA 460, the sections of light-permeable film 466 on or in which colorant has been printed, layered, and/or mixed can be positioned substantially over the sections of light-permeable film 476 on or, in which colorant has been printed, layered, and/or mixed. In embodiments of the present disclosure, at least one of the sections on a first film that is colored with a first colorant color can be positioned over at least one of the sections on a second film that is colored with a second colorant color. Positioning may be accomplished physically through the use of geometry, mechanical, or optical alignment or electronically by adjusting (e.g., maximizing or minimizing) appropriate sensor signals.

As such, the combination of colorant colors can allow transit of light in a portion of a color spectrum having a peak intensity different from each of the peak intensities allowed by the individual colorant colors on the two light-permeable films. For example, the colored section 470 of film 466 positioned over the colored section 480 of film 476 in the embodiment of FIG. 4C can, in some embodiments, allow transit of light in a portion of the color spectrum that can have a peak intensity at a wavelength that is longer than, between, or shorter than the wavelength of the peak intensity transited by colored section 470 and the wavelength of the peak intensity transited by colored section 480.

In various embodiments, the colored section 472 of film 466 can have at least one colorant that is the same as, or different from, the at least one colorant on the same film, for example, in colored section 470. Similarly, the colored section 482 of film 476 can have at least one colorant that is the same as, or different from, the at least one colorant on the same film, for example, in colored section 480.

As described with reference to the CFA embodiments shown in FIGS. 4A-4C, a color measuring device can include a CFA with a number of the filters combining a number of materials, with each material containing one colorant, for example. Embodiments of such combinations can include printing or otherwise depositing the materials containing the colorants on a light-permeable film, where the printed film is positioned between a light source and a sensing circuit, layering the materials containing the colorants on a light-sensing surface of a sensing circuit, and/or mixing the materials containing the colorants for application to a light-permeable material and/or a light-sensing surface of a sensing circuit. Some embodiments can include printing, layering, forming and mixing the at least two materials containing the at least one colorant on a number of light-permeable films, where the films are positioned in a stack between a light source and a sensing circuit.

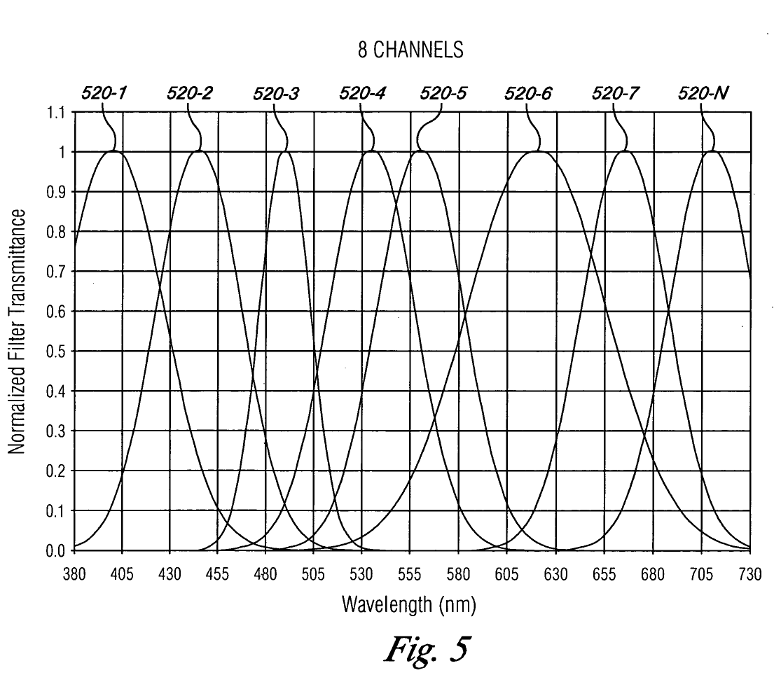

FIG. 5 illustrates a set of example light transmission curves for an eight color filter array according to an embodiment of the present disclosure. The graph 500 illustrated in FIG. 5 shows a representation of relative intensity of light transmittance through various embodiments of color filters on the vertical axis within a spectrum of light wavelengths measured in nanometers (nm) on the horizontal axis.

Each transmission curve can be referred to by the wavelength value of its peak or maximum transmittance value. Each transmission curve also has an associated width. The width can be determined by the wavelengths where the transmittance values fall to some predetermined level (e.g., where the transmittance is 50% of the peak transmittance or falls below 10% without regard to the peak transmittance). For example, if a filter has its peak transmittance value at a wavelength equal to 550 nm and the transmittance falls to 0.1 at wavelengths of 530 nm and 580 nm, the filter can be referred to as the ‘550 nm’ or green filter with a 0.1 bandwidth of 50 nm (580-530 nm).

In the 0.0 to 1.1 scale on the vertical axis of graph 500, a low value can indicate relatively little transmittance of a particular color wavelength through a particular color filter, whereas a value closer to 1.0 can indicate relatively higher transmittance of a particular color wavelength through a particular color filter. The wavelength spectrum shown on the horizontal axis of graph 500 can represent a color spectrum mostly visible to the human eye, which can range from around 380 nm through around 730 nm. The peak transmittance of any particular filter can range anywhere from 0.0 to 1.0. The general shape of the filter curves may also vary substantially from one filter to another.

A graph, such as that shown in FIG. 5, can be used to determine a particular wavelength at which a color filter allows a peak transmittance intensity and its associated bandwidth. By measuring the transmittance of more than one color filter, a determination can be made of a separation distance(s) between the wavelengths of the peak transmittance intensities.

In graph 500, transmittance intensity curves for eight color filters are shown as measured across the visible color spectrum. As discussed herein, the eight color filters can be formed using one or more materials with differing color spectral characteristics. As discussed above, this could also be accomplished by changing the thickness or concentration of the same type of material, or in other manners discussed herein, thereby creating different color spectral characteristics.

Combination of at least two colors and/or other materials having different color spectrum characteristics can result in forming a color filter that transits a peak intensity of a wavelength that can differ from peak wavelengths transited by color filters such as those that are identified as transiting. In some embodiments, combining at least two materials identified with forming color filters can assist in forming a CFA that transits peak intensities of wavelengths spaced across a visible color spectrum. Achieving particular ratios of materials contributing to particular colors can be performed by, in some embodiments, using two layers of B color filters to one layer of G color filter, for example, or by, in some embodiments, mixing double the concentration of a material used in a B color filter with a concentration used in a G color filter, for example.

As illustrated in graph 500 of FIG. 5, a number of curves are shown 520-1, 520-2, 520-3, 520-4, 520-5 520-6, 520-7 . . . 520-N that, by way of example and not by way of limitation, demonstrate transmittance profiles of eight different color filters formed using eight different materials each having a different peak intensity. Using thicker layers of color filters and/or increased concentrations of materials for one color relative to the same color or another color can, in some embodiments, result in a peak intensity wavelength to be shifted relative to those achieved using the individual materials and/or equal combinations of the two. As discussed above, in some embodiments, greater or lesser concentrations of a color can be used.

For instance, increasing the thickness of a color filter, and/or increasing the concentration of materials used to form the color filter, can, in some embodiments, result in decreasing the intensity of light transited by the color filter, including the peak transmittance wavelength. Such peak intensity differences can, in some embodiments, be compensated for using processing circuitry, if it is not useful.

As illustrated by graph 500 in FIG. 5, a number of materials each having a different color spectral characteristic can be used to form an array of color filters transiting at least five portions of a visible color spectrum and, in some embodiments, spanning the visible spectrum. Such embodiments can be beneficial in analyzing the visible spectrum due to the coverage of substantial portions of or the entire spectrum. Various combinations of color filters thus formed can provide a peak intensity of light within one of the portions of the color spectrum to the circuitry for sensing.

In various embodiments, appropriate combinations of materials can enable selecting color filters such that the peaks of the portions can be spaced at intervals across the visible color spectrum. Using various embodiments described in the present disclosure, a color measuring device can have color channel spacing that can be determined by spacing of a peak intensity of light transiting each filter associated with each channel through a number of sensing circuits.

In some embodiments, the overlap of the color channels can be used to more specifically identify a color sensed by using information collected via more than one of the color channels. In this manner, the combination of color channel information can provide more accurate information and can reduce or eliminate instrumental metamerism.

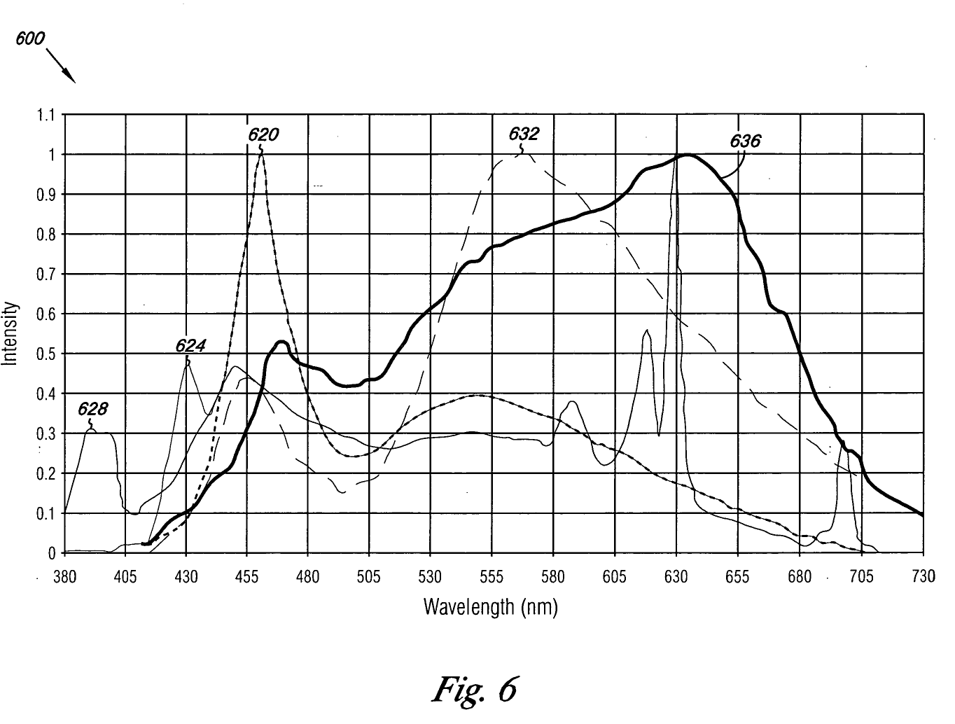

FIG. 6 illustrates a representation of light sources emitting light with differing intensities across a visible color spectrum according to an embodiment of the present disclosure. Suitable light sources can, for example, be gas discharge, incandescent, or LED-based, among others. The selection can be based upon a number of factors. For example, LED's are convenient since they can be easier to drive, less expensive, and/or thermally cooler, than the above mentioned gas discharge and incandescent examples.

Embodiments of the present disclosure can utilize a number of light sources having different light emitting characteristics. In providing such light sources, the device can be applied in a number of situations. For example, the device can be designed with suitable light sources to provide color accuracy, measurement according to industry standards, and/or measurement of special materials, among other functions.

The graph 600 illustrated in FIG. 6 shows a representation of relative intensity of light emitted by various embodiments of light-emitting diodes (LEDs), and combinations thereof, on the vertical axis within a spectrum of light wavelengths measured in nm on the horizontal axis.

In the 0.0 to 1.0 scale on the vertical axis of graph 600, a low value can indicate relatively little emission of a particular color wavelength by a particular LED, or a particular combination of LEDs, whereas a value closer to 1.0 can indicate relatively higher emission of a particular color wavelength by a particular LED, or a particular combination of LEDs. The wavelength spectrum shown on the horizontal axis of graph 600 represents a color spectrum mostly visible to the human eye, which can range from around 380 nm through around 730 nm. This range should not be viewed as limiting the embodiments of the present disclosure and greater, lesser, higher, or lower ranges may be used with the various embodiments of the present disclosure.

A graph such as that shown in FIG. 6 can be used to determine particular wavelengths at which a particular LED, a particular combination of LEDs, and/or other light sources, emit one or more peaks and valleys of intensity at wavelengths throughout a color spectrum, along with relative emission intensities in between. In graph 600, emission intensity curves for five particular LEDs, or particular combinations of LEDs, are shown as measured across the visible color spectrum.

As further described below, a particular LED that emits light in a defined wavelength range can be combined with a particular phosphor(s) that can be excited by the light emitted by the LED and can emit light having a range of longer light wavelengths to broaden the color spectrum of the light emitted by the LED light source. The five LED light sources shown in graph 600 were formed using a number of individual LEDs with a specific phosphor(s), or combinations thereof. Some embodiments may be formed without specific phosphors or combinations, but rather, other suitable LED characteristics may be utilized for such selection of LED's.

Illuminating an object to enable potential reflection of light wavelengths ranging across a visible color spectrum, and thereby enabling adequate measurement of the object's colors, can be achieved using light sources that emit relatively high intensities of light, across the spectrum to be measured, for example, from around 380 nm through around 730 nm, in some embodiments. Some spectrophotometers can use a light source such as a tungsten lamp that can provide a broad range of illumination. However, such devices are often expensive. A less expensive color measuring device can use a “white light LED”, as described below, among other light sources.

The graph 600 illustrated in FIG. 6 shows a range of light emission intensities that can be produced by an embodiment utilizing “white light” LED's. A white light LED can include a LED that emits blue light wavelengths combined with a yellow phosphor that can become excited by the blue light wavelengths to emit a range of longer wavelengths of light.

A curve 620 illustrating intensities of light in a visible spectrum that can be produced by an embodiment of a white light LED is shown in graph 600. The curve 620 shows that a white light LED can emit light having high intensity (normalized to 1.0) in the blue region of the color spectrum with more moderate intensities (from around 0.2 to around 0.4) in to the orange-red region of the color spectrum.

Notably, as shown in the curve 620 of graph 600, the white light LED embodiment can emit an intensity that drops from around 0.1 to around 0.0 at wavelengths shorter than around 430 nm. Because objects can reflect light or absorb and re-emit light as a result of illumination in a short wavelength region (e.g., 360-430 nm), illumination of an object with a white light LED that does not emit wavelengths that short, can introduce error in color measurements made by a color measurement device.

Complying with a particular color imaging standard (e.g., an ISO Proofing Standard) can involve illuminating an object with a light source that includes specific wavelengths and/or wavelength ranges. For example, some high-brightness print medium can have “brighteners” to enhance the appearance of ‘whiteness’. Consequently, a brightener can increase brightness so that a print medium appears whiter than it would otherwise appear. Such high-brightness print medium may utilize short wavelength light to excite the brighteners. Some ISO Proofing Standards specify that brighteners are to be excited with light sources that emit wavelengths in the 380-420 nm range. This is typically not possible with ‘white’ or ‘warm white’ LED's.

As illustrated in graph 600 of FIG. 6, curve 624 shows that an embodiment of an “ultra-blue” LED can emit light with a peak wavelength around 430 nm. The embodiment of the ultra-blue LED used for curve 624 can emit light at around 420 nm with an intensity of around 0.2, which is notably higher than the intensity emitted by the white light LED at 420 nm shown in curve 620.

To improve accuracy of color measurement and/or better comply with applicable imaging standards (e.g., the ISO Proofing Standard), a light source can be used for illuminating an object to be measured that includes an array of at least two LEDs each having different color characteristics, wherein a combination of emitted light substantially covers the visible color spectrum. For example, graph 600 of FIG. 6 illustrates an embodiment of combining the ultra-blue LED with the white light LED by showing the light emission curve 624 of the ultra-blue LED merging with the light emission curve 620 of the white light LED.

To more strongly excite brighteners in a print medium (e.g., to comply with the ISO Proofing Standard), a light source can be used having higher intensity emissions in wavelengths closer to 380 nm. For example, graph 600 of FIG. 6 illustrates an emission curve 628 for an embodiment of a “super-white” LED.

The embodiment of the super-white LED illustrated in graph 600 can be formed, for example, using a violet LED combined with three phosphors. The curve 628 for the super-white LED shows an emission intensity having a broad peak (around 0.3) from around 390-400 nm. In some embodiments, combining the super-white LED with the ultra-blue LED and/or the white light LED can provide relative uniformity in the shorter wavelengths of the visible spectrum.

However, as shown in curve 628, at longer wavelengths (e.g., around 615-630 nm and around 700 nm) the super-white LED embodiment can have notable spikes in emission intensity. Hence, in some embodiments, accuracy of color measurement may decrease when using a super-white LED. Consequently, having an ability to selectively turn off and on any of the available light sources to perform a particular measurement task can be advantageous.

Graph 600 of FIG. 6 illustrates an emission curve 632 for a first embodiment of a “warm-white” LED. The warm-white LED can be formed using a blue LED combined with a particular combination of yellow and red phosphors. The curve 632 for the warm-white LED shows an emission intensity reaching a peak (at around 1.0) at a wavelength around 560-570 nm in the green portion of the color spectrum. However, in such an embodiment as that illustrated in FIG. 6, there still is virtually no illumination below about 410 nm.

From the peak, the curve 632 shows intensities that decline gradually as wavelengths reach the red and far-red portions of the color spectrum (e.g., the intensity reaches around 0.2 at around 705 nm). In some embodiments, combining the warm-white LED with the super-white LED, the ultra-blue LED, and/or the white light LED can provide increased intensity and/or relative uniformity in the longer wavelengths of the visible spectrum.

Graph 600 of FIG. 6 illustrates an emission curve 636 for a second embodiment of a “warm-white” LED. The second embodiment of the warm-white LED can be formed using a blue LED combined with a particular combination of yellow and red phosphors that differ from the phosphors used in the first embodiment of the warm-white LED.

The curve 636 for the warm-white LED shows an emission intensity reaching a peak (at around 1.0) at a wavelength around 630-640 nm in the red portion of the color spectrum. From the peak, the curve 636 shows intensities that decline more sharply than the 632 curve as wavelengths reach the far-red portion of the color spectrum (e.g., where the intensity also reaches around 0.2 at around 705 nm).

In some embodiments, combining the second embodiment of the warm-white LED with the first embodiment of the warm-white LED, the super-white LED, the ultra-blue LED, and/or the white light LED can provide increased intensity and/or relative uniformity in the longer wavelengths of the visible spectrum. Hence, an illumination system for a color measuring device can include a number of embodiments of LEDs and/or other light sources, each of which can be turned on and off independently, or in programmed combinations, to improve color measurement and/or to comply with a particular imaging standard and/or to match interests of a particular user.

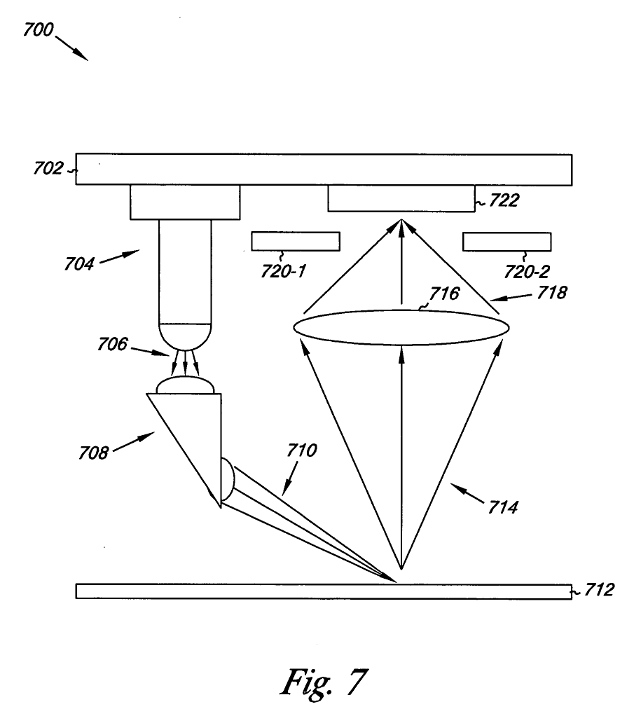

FIG. 7 illustrates a configuration for directing incident light and receiving reflected light according to an embodiment of the present disclosure. FIG. 7 illustrates a 45/0 type measurement geometry (e.g., 45 degrees from the vertical illumination and 0 degrees from the vertical reading) configuration for a color measuring device 700. Various modifications, such as those provided in this example, can compensate for object deformation, e.g., paper bending or ‘cockle.’

The color measuring device 700 illustrated in FIG. 7 shows that the device can be associated, in some embodiments, with a portion including circuitry 702 (e.g., a printed circuit board) that can, in some embodiments, be connected to processing circuitry (not shown). A light source 704, which, in some embodiments, can include a LED, can be associated with the circuitry 702 to provide light 706 having particular color spectral characteristics for illumination of an object. Illuminating an object with the light source 702 can enable measurement of light reflected therefrom in at least five portions of the color spectrum, according to embodiments of the present disclosure.

In various embodiments, the color measuring device 700 shown in FIG. 7 can direct light 706 emitted by, for example, a LED 704 toward a position on an object at substantially a 45 degree angle so that light reflected substantially perpendicularly from a surface (e.g., a 0 degree reflection) can be measured. Illuminating an intended position on an object can be accomplished by a component 708 (e.g., a lightpipe) that receives light 706 emitted, for example, from the LED 704. The lightpipe 708, for example, can direct the light 710 in a manner so that the light 710 reaches the intended position of the object 712 to be measured (e.g., a sheet of print medium). The lightpipe can not only direct the light but can affect the shape as well as modify the uniformity of the light striking the object

When the surface of a print medium, for example, to be measured has a deformity (e.g., a cockle), the deformation alters the expected angular orientations of the surface to be measured. Consequently, both the angles of the incident light and the reflected light can be affected such that the angles differ from what would otherwise be observed.

Reflection from a cockled surface can create a deviation from the substantially 0 degree reflection angle expected from the intended position of a print medium, for example, as to direct the reflected light to partially or substantially miss an intended sensor and/or it can change the nature of the reflected light. Hence, in some instances, cockles and other deviations in a print medium can reduce the ability of a color measuring device to make accurate color measurements.

For example, when the print medium 712, for instance, in FIG. 7 has a cockle at the intended position of the directed light 710, the reflected light 714 can be reflected in a variety of unpredictable directions. The middle line in the reflected light 714 can represent a 0 degree reflection of the 45 degree directed light 710 from the expected position of the print medium 712.

The outside lines of the reflected light 714 can represent a two-dimensional illustration of a three-dimensional cone of reflection of light. Based upon a number of considerations, for example, some of which may be related to a probable extent of anticipated deformity, or cockling, the size, shape, and/or nature of a light cone of interest can be determined.

As illustrated in FIG. 7, a color measuring device 700 can include a component for directing 716 (e.g., a pickup lens) the anticipated size of the light cone of interest. The lens 716, for example, can direct (e.g., focus) the reflected cone of light 714 into light 718 redirected toward a sensor array 722. Ambient light and/or undirected light (e.g., light unfocused by the pickup lens 716) can, in some embodiments, be substantially blocked from passing a particular location in a pathway of directed light 718 by using an arrangement of filters and/or baffles 720-1, 720-2 having, in some embodiments, a circular opening (e.g., a telecentric stop). A goal of a telecentric lens or similar optical design is to increase the depth of focus to decrease the color accuracy sensitivity to cockle and other positional errors.

As illustrated in the embodiment of the color measuring device in FIG. 7, a sensor array 722 (e.g., a CFA in accordance with embodiments of the present disclosure) can be positioned to receive the light 718 directed by the pickup lens 716, for example. The CFA sensors 722, for example, can be associated with a portion including circuitry 702 (e.g., a printed circuit board) that can, in some embodiments, be connected to processing circuitry (not shown).

In some embodiments, as shown in FIG. 7, the circuitry 702 portion associated with the light source 704 can be the same circuitry portion 702 associated with the sensor array 722 (e.g., the same printed circuit board as 702). In some embodiments, the circuit board can utilize an application-specific integrated circuit.

By using multiple color filters and multiple light sources, it is possible to approximately reconstruct the spectral response of a reflective sample. This is typically often desired for Graphics Arts purposes, among use in other fields. Colorants found in everyday items generally have a well-behaved spectral characteristic, and the full spectrum can be reconstructed relatively accurately from the limited number of channels provided by the abridged spectrophotometer.

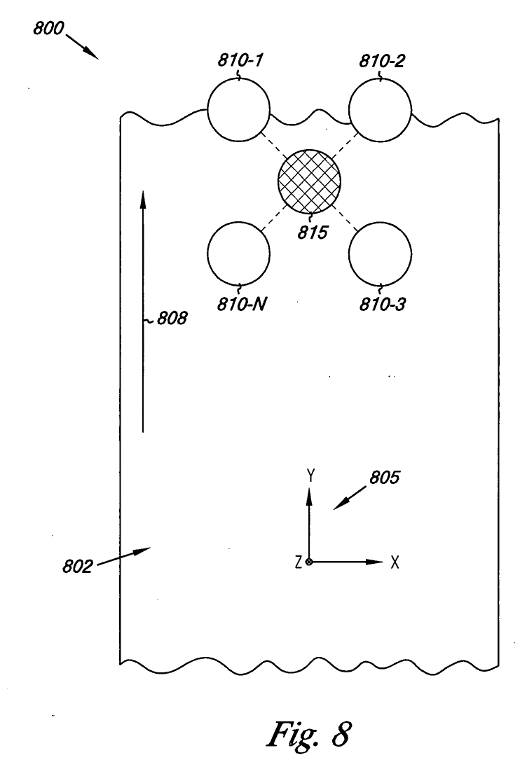

FIG. 8 illustrates another configuration for directing incident light and receiving reflected light according to an embodiment of the present disclosure. FIG. 8 illustrates a configuration for a color measuring device 800 that can compensate, at least in part, for a deformity on an object being measured from affecting the ability of the color measuring device 800 to receive reflected incident light that enables color measurement of the object having the deformity (e.g., a sheet of print medium) by using multiple light sources directed toward an intended position. The individual light sources may be similar to that shown in FIG. 7, by way of example and not by way of limitation.

For a sensor of a color measurement device included in an imaging device (e.g., a printer) where the print medium is moving, the movement of the print medium can affect a color measurement by causing formation of a deformity (e.g., a cockle) in the print medium, as described above. In some color measurement devices an annular ring light source can be used, which can illuminate an object from all sides in order to reduce the effect of a deformity.

Annular ring light sources, however, can be large and/or expensive, which can limit use of the annular ring light source in a number of consumer products (e.g., a portable color sensing device). As described below, a number of individual light sources can be placed around and directed toward a position to be measured on a moving print medium.

Such embodiments may be smaller and more cost effective. In such embodiments, a sensor(s) that detects reflected light emitted by a number of light sources arranged around the position to be measured can be connected to processing circuitry that averages, sums, or determines the differences of the intensity readings which can, in turn, be used to reduce the effects of a deformity at the position being measured.

The color measuring device embodiment 800 illustrated in FIG. 8 shows that the device can operate in association with, in some embodiments, a print medium 802 (e.g., individual sheets, a continuous web, etc.) that can induce various deformities (e.g., cockle) causing the print medium to undergo displacement in at least one of three dimensions 805 (x, y, and z). In some embodiments, the cockle, for example, can be caused by movement 808 of the print medium substantially in the direction (y) of a color measuring device and/or a printhead.

In the embodiment of the color measuring device 800 illustrated in FIG. 8, a number of light sources can be positioned around a position on the print medium 802 to be measured. In the embodiment illustrated in FIG. 8, four light sources 810-1, 810-2, 810-3, . . . 810-N are shown by way of example and not by way of limitation. The four light sources can, in various embodiments, include LEDs and/or alternative light sources.

The four light sources shown in the embodiment of color measuring device 800 can, for example, be positioned at substantially equal angles (e.g., at substantially 90 degrees) at substantially equal distances on radii of a circle surrounding a sensor 815 (or a CFA in accordance with embodiments of the present disclosure). Substantially equal spacing of the light sources can assist in illuminating a position on a print medium from as many different directions as allowable given the number of light sources in order to achieve effective illumination of a cockled surface, for example. However, the embodiments of the present disclosure are not limited to substantially equal spacing of light sources being used.

In some embodiments of the color measurement device 800 illustrated in FIG. 8, light can be directed toward an intended position on the print medium 802 by each of the light sources 810-1, 810-2, 810-3, . . . 810-N at a substantially 45 degree angle. In some embodiments, the sensor 815 can be positioned at a 0 degree angle relative to the expected angular orientation on the surface to be measured.

If the paper varies in the z-direction along the y-direction, the amount of light reflected from illumination sources 810-1 and 810-2 may increase while the light reflected from sources 810-3 and 810-N may decrease. The difference between the signal produced by sources 810-1 and 810-2 and the signal produced by 810-3 and 810-N can be indicative of the amount of cockle whereas the sum or average of the four signals will improve the accuracy versus a single illumination source.

In various embodiments, using more than one light source (e.g., the four shown in FIG. 8) in a color measuring device can allow reflected light to be received by an array of color filters associated with at least one sensor, and allow an averaged intensity of reflected light in a sensed portion of the color spectrum to be used as a measurement thereof. In various embodiments, light can be emitted substantially simultaneously by more than one light source and a cumulative intensity can be detected by a sensor or light can be emitted in a programmed sequence by more than one light source so that the sensor can detect pulses of reflected light.

A sensor can be associated with processing circuitry that can calculate an average intensity by dividing a cumulative intensity by the number of light sources and/or can calculate an average intensity by adding the pulse intensities and dividing by the number of light sources. In some embodiments, processing circuitry can use other statistical methods (sum, differential, etc.) to handle received intensity measurements.

As described above, the potential effect on color measurement of an object having a deformation on a surface being measured by a color measuring device can be reduced by using the configuration and methodologies described in association with FIG. 7 and/or the configuration and methodologies described in association with FIG. 8 for directing incident light and receiving reflected light.

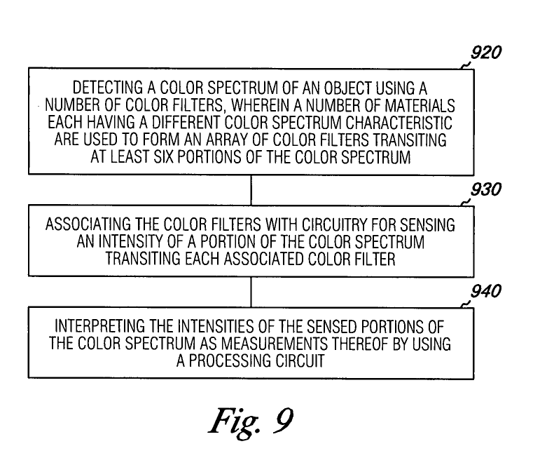

FIG. 9 is a block diagram illustrating a method of measuring color according to an embodiment of the present disclosure. Unless explicitly stated, the method embodiments described herein are not constrained to a particular order or sequence. Additionally, some of the described method embodiments, or elements thereof, can occur or be performed at the same, or at least substantially the same, point in time.

The embodiments described herein can be performed using logic, software, hardware, application modules, or combinations of these elements, and the like, to perform the operations described herein. Embodiments as described herein are not limited to any particular operating environment or to software written in a particular programming language. In various embodiments, the elements just described can be resident on the systems, and/or devices shown herein, or otherwise.

Logic suitable for performing embodiments of the present disclosure can be resident in one or more devices and/or locations. Processing modules used to execute operations described herein can include one or more individual modules that perform a plurality of functions, separate modules connected together, and/or independent modules.

The embodiment illustrated in FIG. 9 includes detecting a color spectrum of an object using a number of color filters, wherein a number of materials each having a different color spectral characteristic are used to form an array of color filters transiting at least five portions of the color spectrum, as shown in block 920 and as described above.

Block 930 of the embodiment shown in FIG. 9 includes associating the color filters with circuitry for sensing an intensity of a portion of the color spectrum transiting each associated color filter, as described above. Additionally, block 940 of the embodiment shown in FIG. 9 includes interpreting the intensities of the sensed portions of the color spectrum as measurements thereof by using a processing circuit, as described above.

Although specific embodiments have been illustrated and described herein, those of ordinary skill in the art will appreciate that an arrangement calculated to achieve the same techniques can be substituted for the specific embodiments shown. This disclosure is intended to cover all adaptations or variations of various embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method of measuring color via an abridged spectrometer, comprising:
detecting a color spectrum of an object using an abridged spectrometer having a number of color filters;
wherein a number of materials each having a different color spectral characteristic are used to form an array of color filters transiting at least five portions of the color spectrum;
utilizing at least five color filters having different spectral characteristics;
associating the color filters with circuitry for sensing an intensity of a portion of the color spectrum transiting each associated color filter; and
interpreting the intensities of the sensed portions of the color spectrum as measurements thereof by using a processing circuit.

2. The method of claim 1, wherein utilizing at least five color filters includes utilizing at least one of the color filters that is a combination of at least two of the number of materials.

3. The method of claim 1, wherein utilizing at least five color filters having different spectral characteristics includes utilizing at least five color filters integrally formed on top of a portion of the circuitry for sensing.

4. The method of claim 1, wherein utilizing at least five color filters having different spectral characteristics includes utilizing at least five color filters overlaid on top of at least a portion of the circuitry for sensing.

5. The method of claim 1, wherein utilizing at least five color filters having different spectral characteristics includes utilizing at least one color filter positioned on top of multiple sensors provided as part of the circuitry for sensing.

6. The method of claim 1, wherein utilizing at least five color filters having different spectral characteristics includes utilizing at least five color filters where at least one filter is positioned over more sensors of the circuitry for sensing than another one of the at least five color filters.

7. The method of claim 1, wherein detecting a color spectrum of an object using an abridged spectrometer having a number of color filters includes detecting a color spectrum of an object using an abridged spectrophotometer having a number of color filters for receiving reflected light.

8. The method of claim 1, wherein detecting a color spectrum of an object using an abridged spectrometer having a number of color filters includes detecting a color spectrum of an object using an abridged spectroradiometer having a number of color filters for receiving emissive light.

9. The method of claim 1, wherein interpreting the intensities of the sensed portions of the color spectrum as measurements thereof by using a processing circuit includes reconstructing a spectra from a reflective object.

10. The method of claim 1, wherein transiting at least five portions of the color spectrum is performed by using each of at least five color filters to provide light within one of the portions of the color spectrum to the circuitry for sensing the intensity thereof and by selecting the color filters such that the portions are spaced across a range that substantially covers a visible color spectrum.

11. A color measuring device, comprising:
a color filter array including at least five color filters having different spectral characteristics;
a number of sensing circuits for sensing light transiting at least one of the filters, wherein each of the filters is associated with at least one sensing circuit;
a processing circuit to interpret the color spectral characteristics of the sensed light as at least five color channels; and
wherein the number of filters used enables the device to measure the color channels as spaced in a color spectrum.

12. The color measuring device of claim 11, wherein at least one of the at least five filters has at least two materials formed therefrom, wherein each of the at least two materials has a different color spectral characteristic.

13. The color measuring device of claim 11, wherein at least one of the filters has at least two materials thereon and combines at least two materials each containing at least one colorant by using a group including:
printing the materials containing the colorants on a light-permeable film, wherein the printed film is positioned between a light source and a sensing circuit;
layering the materials containing the colorants on a light-sensing surface of a sensing circuit;
mixing the materials containing the colorants for application to a light-permeable film and a light-sensing surface of a sensing circuit; and
printing, layering, and mixing the at least two materials containing the at least one colorant on a number of light-permeable films, wherein the films are positioned in a stack between a light source and a sensing circuit.

14. The color measuring device of claim 11, wherein the device includes:
a user interface to control an application software package being utilized and to enter information associated with an object being measured; and
a display window allowing the user to access the light color spectrum measurement in real time, the information associated with the object being measured as the information is being entered, and a stored light color spectrum measurement and stored information associated with a measured object.

15. A method of measuring color, comprising:
illuminating an object with an array of at least two light sources each having different color characteristics, wherein a combination of emitted light substantially covers a visible color spectrum;
detecting a color spectrum of the object using a number of color filters, wherein a number of materials each having a different color spectral characteristic are used to form an array of color filters transiting at least five portions of the color spectrum;
utilizing at least five color filters having different spectral characteristics;
associating the color filters with circuitry for sensing an intensity of a portion of the color spectrum transiting each associated color filter; and
interpreting a number of intensities of sensed portions of a color spectrum as measurements thereof.

16. The method of claim 15, wherein illuminating an object with an array of at least two light sources includes illuminating an object with an array of at least two light-emitting diodes.

17. The method of claim 16, wherein illuminating an object with an array of at least two light sources includes illuminating an object with an array of at least two different types of light sources.

18. The method of claim 17, wherein the method includes switching the at least two light sources between an on state and an off state independently.

19. The method of claim 15, wherein illuminating an object with an array of at least two different types of light sources includes illuminating an object with an array of at least two light sources selected from a group of light source types including;
a white light source;
a warm white light source;
an ultra-blue light source; and
a super-white light source.

20. The method of claim 15, wherein the method includes illuminating the object with a number of light sources and directing light emitted from each to an intended position of the object at substantially 45 degree angles.

21. The method of claim 15, wherein the method includes receiving light reflected substantially perpendicular from a surface of the object and directing the light toward the array of color filters.

22. The method of claim 15, wherein the method includes using more than one light source, receiving reflected light using the array of color filters, and using an averaged intensity of reflected light in a sensed portion of the color spectrum as a measurement thereof.
